(19) United States
(12) Patent Application Publication
(10) Pub. No.: US 2018/0341898 A1
(43) Pub. Date: Nov. 29, 2018

(54) DEMAND FORECAST

(71) Applicant: SEARS BRANDS, L.L.C., Hoffman Estates, IL (US)

(72) Inventors: Suvadeep Bose, Aurora, IL (US); Vijay Veeraghattam, Carpentersville, IL (US); Llewellyn Bezanson, Port Townsend, WA (US); Taraknath Woddi, Renton, WA (US)

(21) Appl. No.: 15/989,076

(22) Filed: May 24, 2018

Related U.S. Application Data
(60) Provisional application No. 62/510,433, filed on May 24, 2017.

(51) Int. Cl. G06Q 10/06; G06Q 30/02; G06N 99/00

(52) U.S. Cl. CPC G06Q 10/06315; G06N 99/005; G06Q 30/0202

(57) ABSTRACT

Techniques for demand forecast use a SIM-TO engine to identify similar-to items for a new item, thereby enabling to provide demand forecast for the new item. The SIM-TO engine determines a classification of a new item, identifies a set of attributes of the new item, and searches existing items within the determined classification using the set of attributes. One or more existing items are identified as similar-to items in response to a determination that their respective matching scores are equal to or greater than a predetermined threshold value.

### BACKGROUND

Providers of products and services may distribute a variety of products and services over a wide geographic area and through a number of outlets. Such providers need an accurate forecast of customer demand in order to optimize supply-chains and minimize operating costs. Conventional forecasting techniques analyze historical data corresponding to one or more items to formulate predictions about future demand for the one or more items. However, the accuracy of conventional forecasts cannot fulfill the needs of providers who distribute a wide variety of products or services over a wide geographic area. Furthermore, providers frequently introduce new items to their customers, and the current forecasting techniques cannot predict demand for the new items because there are no historical data corresponding to such new items. In sum, conventional forecasting systems, including computational systems, suffer from the technological problem of being unsuited to efficiently provide reliable demand forecast data for new items or services that may be introduced at widely distributed retail locations.

### SUMMARY

In an illustrative embodiment of the disclosed invention, a demand forecasting system includes a forecast engine configured to generate forecast data; a history database; a plurality of data collectors; a SIM-TO engine; a forecast database; and an application unit. The forecast engine and the forecast database are configured to provide inputs to the application unit to plan promotion activities, achieve optimal inventory and resource allocation, and minimize operating costs. In addition, at least some of the forecast data generated by the forecast engine is stored in the forecast database. Moreover, the SIM-TO engine comprises a processor and a computer readable medium containing instructions that, upon execution by the processor, cause the SIM-TO engine to perform a process to identify items that are similar to a new item identified by the data collector, enabling the forecast engine to provide forecast data indicative of a demand forecast for the new item.

In the illustrative embodiment, the process to identify items that are similar to a new item includes determining a classification of the new item; identifying a set of attributes of the new item; calculating matching scores for existing items within the determined classification, wherein the matching scores are calculated using the set of attributes; and identifying an existing item as similar to the new item in response to determining that a matching score for the existing item is equal to or greater than a predetermined threshold value.

In the illustrative embodiment, the determined classification comprises a hierarchy of classifications, including as a division, a category, and a subcategory. The process to identify items that are similar may also include performing an expanded search of existing items by conducting a search within a higher level of classification. The process to identify items that are similar may also include adjusting the set of attributes and the predetermined threshold value so as to identify a desirable number of similar-to items.

The forecast engine may be configured to divide gathered data from the data collectors into a set of training data and a set of test data; train a plurality of machine learning models using the set of training data; generate fitness functions for the plurality of machine learning models; select a model with the highest degree of fitness across the set of training data; evaluate forecast accuracy of the selected model using the set of test data; and determine whether the forecast accuracy of the selected model is acceptable. The system may also be configured to update the forecast data generated by the selected model as data associated with existing or similar-to items become available. In addition, the system may be configured to monitor the forecast accuracy of the selected model on an on-going basis; and/ or to adjust the data gathered by the forecast engine to improve the forecast accuracy of one or more machine learning models.

The plurality of data collectors may be located in a number of stores of a retail entity and are configured to collect various data relating to items sold by the retail entity, including locations of stores, categories and descriptions of items, times, prices and sales; and wherein the data collected by the data collectors is stored in the history database. The forecast engine and the SIM-TO engine are preferably accessible via an application programming interface (API) or user interface, and the forecast engine and SIM-TO engine preferably provide an analysis and summary of results to a requesting user.

The illustrated method of calculating matching scores for existing items, in the illustrative embodiment, comprises assigning a value of “1” to an existing item if the existing item has an attribute matching one among the set of attributes of the new item, and otherwise assigning a value of “0” to the existing item. Here, a matching score of each existing item is determined by dividing a sum of values assigned to each existing item by the number of attributes among the set of attributes.

Other features of the disclosed invention are described below.

### BRIEF DESCRIPTION OF DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 is a diagram illustrating a network environment of a system for demand forecast in accordance with the present disclosure;

FIG. 2 is a simplified diagram illustrating example data metrics of a database that may be used in accordance with the present disclosure;

FIG. 3 is a flowchart illustrating an example process for identifying similar-to items in accordance with the present disclosure;

FIG. 4 is a chart illustrating a comparison of attributes between a new item and an similar-to item identified by a SIM-TO engine in accordance with the present disclosure;

FIG. 5 is a flowchart illustrating an example process for demand forecast in accordance with the present disclosure;

FIG. 6 is a chart illustrating an example of a forecast for a given division generated by a forecast engine in accordance with the present disclosure;

FIG. 7 is a chart illustrating an example of a forecast for a given item within a given division derived from a forecast for the given division by a forecast engine in accordance with the present disclosure;

FIG. 8 is a chart illustrating a portion of a promotional forecast for a given subcategory by a forecast engine in accordance with the present disclosure;

FIG. 9 is a chart illustrating an example of a promotional forecast for a given item by a forecast engine in accordance with the present disclosure;

FIG. 10 is a chart illustrating an example of a forecast for a new item by a SIM-TO engine and a forecast engine in accordance with the present disclosure;

FIG. 11 is a chart illustrating comparisons between actual data and forecasted data associated with identified similar-to items;

FIG. 12 is a diagram illustrating an example computing system that may be used in some embodiments.

### DETAILED DESCRIPTION

Techniques for demand forecast are described herein. The disclosed techniques may use a SIM-TO engine to identify similar-to items for a new item, which enables the system to provide a demand forecast for the new item. In some embodiments, the SIM-TO engine determines a classification of a new item, identifying a set of attributes of the new item, and searching existing items within the determined classification using the set of attributes. One or more existing items are identified as similar-to items in response to determinations that their respective matching scores are equal to or greater than a predetermined threshold value.

In some examples, the determined classification may comprise a hierarchy of classifications, such as a division, a category, and a subcategory. In some embodiments, a scope of searching existing items may be expanded by conducting a search within a higher level of classification. In other embodiments, the set of attributes and the predetermined threshold value may be adjusted so as to identify a desirable number of similar-to items.

The disclosed techniques may also include a forecast engine. In some examples, the forecast engine may provide demand forecast for a given classification of items. The forecast engine may also generate demand forecast for an existing items. In other examples, the forecast engine may compute demand forecast for a new item using a data collection constructed from historical data associated with similar-to items identified by the SIM-TO engine.

As described herein, the forecast engine may divide gathered data into a set of training data and a set of test data. These two sets of data are independent from each other. The forecast engine may train a plurality of machine learning models using the set of training data, generate fitness functions for the plurality of machine learning models, and select a model with the highest degree of fitness across the set of training data. The forecast engine may evaluate forecast accuracy of the selected model using the set of test data and determine whether the forecast accuracy of the selected model is acceptable.

In some embodiments, forecast data generated by the selected model may be updated as latest data associated with existing or similar-to items become available. The forecast accuracy of the selected model may be monitored on an on-going basis. In other embodiments, the data gathered by the forecast engine may be adjusted in order to improve forecast accuracy of one or more machine learning models. In some examples, the SIM-TO engine may be employed to acquire a sufficient data collection for training and testing forecast models.

Techniques for demand forecast are described herein with particular reference to preferred exemplary embodiments. However, it should be understood that these embodiments provide only a few examples of the many advantageous uses of the innovative techniques in accordance with the present disclosure. In general, statements made in the specification of the present disclosure do not necessarily delimit any of claimed methods, systems or computer-readable media.

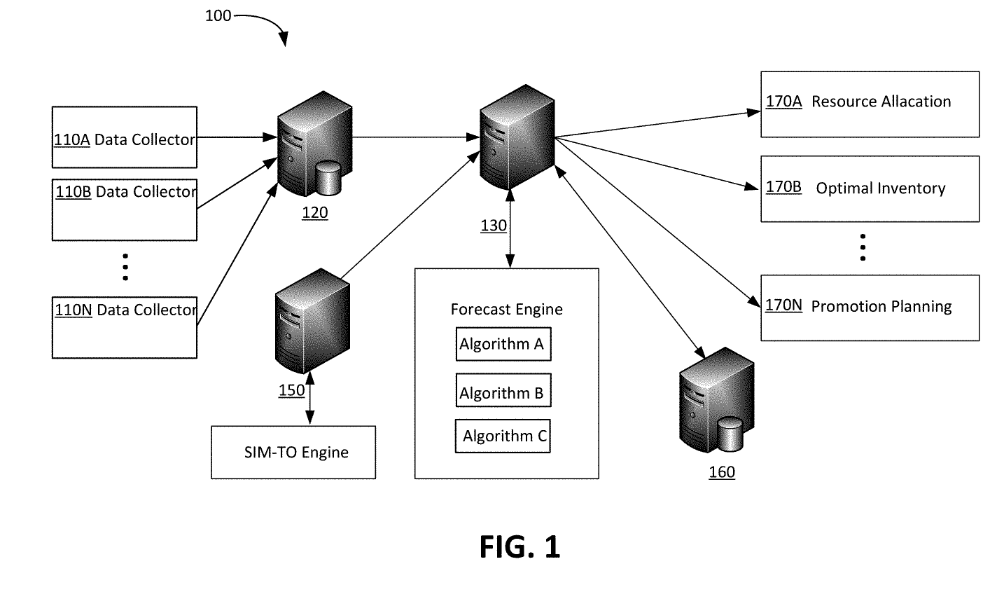

FIG.1 illustrates an example system 100 for demand forecast in accordance with the present disclosure. The system 100 may be used by any provider who provides products or services over a wide geographic area or through a number of outlets, such as chain department stores, Internet-based electronic commerce sites, and on-line video providers. By way of example and without limitation, a retail entity may use the system 100 to optimize supply-chain, plan promotion activities, and minimize operating costs. While embodiments of a retail entity using the system 100, for convenience and simplicity, will be described in greater detail below, it is to be understood that the present disclosure is not limited to a retail industry and could equally apply to any providers who provide products or services.

As shown in FIG.1, the system 100 comprises a plurality of data collectors (collectively 110), one or more history databases (collectively 120), a forecast engine 130, a SIM-TO engine 150, one or more forecast databases 160, and one or more application units (collectively 170). The forecast engine 130 or the forecast databases 160 may provide inputs to the application units 170 so as to plan promotion activities, achieve optimal inventory and resource allocation, and minimize operating costs. The data generated by the forecast engine 130 may be stored in the forecast databases 160. In some embodiments, the forecast data may be fed back into the forecast engine 130 for demand forecast.

It should be appreciated that the network topology illustrated in FIG. 1 has been greatly simplified and that many more networks and devices may be utilized to interconnect the various computing systems disclosed herein. It should also be appreciated that the system 100 described in FIG. 1 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, cellphones, wireless phones, pagers, electronic organizers, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

The plurality of data collectors 110 may be located in a number of stores of a retail entity and collect various data relating to items sold by the retail entity, including locations of stores, categories and descriptions of items, times, prices and sales. The plurality of data collectors 110 may be tablet computers, laptop computers, desktop computers or any other sort of devices and capable of transmitting data via any suitable communication networks. The data collected by the data collectors 110 may be transmitted to one or more servers or computing devices and stored in the history databases 120.

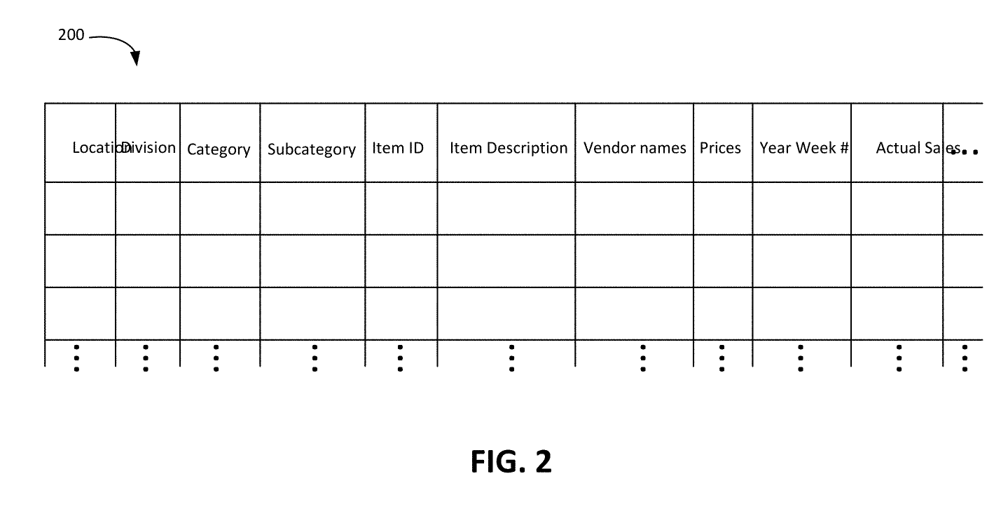

FIG. 2 is a simplified diagram illustrating example data metrics 200 of the history databases 120 in accordance with the present disclosure. As illustrated, data metrics 200 may include location, division, category, subcategory, item ID, item description, vendor names, prices, year-week No., actual sales, and so on. The forecast databases 160 may include data metrics similar to those of the history databases 120. The forecast databases 160 may further include forecasted data. The history databases 120 and the forecast databases 160 may be organized in any suitable way that can support operations of the forecast engine 130 and the SIM-TO engine 150. The history databases 120 and the forecast databases 160 may be updated over time as new data becomes available. The history databases 120 and the forecast databases 160 may be broken into subsets of data and processed in parallel by separate servers or computing devices.

The forecast engine 130 may provide accurate forecast at various hierarchy levels. In some embodiments, the forecast engine 130 may generate demand forecast for a category level at a given location. For example, the forecast engine 130 may forecast demand for the category of women's apparel in New York stores. In other embodiments, the forecast engine 130 may forecast demand for a particular item at a given location or nationwide. The particular item may be an existing item or a brand new item. The forecast engine 130 may access various data, such as data stored in the history databases 120 and data generated by the SIM-TO engine 150. The forecast engine 130 may also generate or cause the generation of data. The forecast engine 130 will be described in greater detail below.

The forecast engine 130 and the SIM-TO engine may be made accessible via an application programming interface (API) or a user interface that may be accessed via a Web browser or other input mechanisms. The forecast engine 130 and the SIM-TO engine may provide a detailed analysis and summary of results to the requesting user. The results may be presented in various manners, such as data tables, graphs and diagrams.

Providers of products or services may frequently introduce new items to their customers. For instance, a retail entity introduces new seasonal apparels every year. These new seasonal apparels have sparse or no prior sales history and the retail entity encounters difficulties in addressing timely replenishment of inventory in stores, procuring appropriate inventory at the right time, determining competitive prices, optimizing resource allocation, and minimizing operation costs. The present disclosure provides new and improved techniques for forecasting demand of new items.

The SIM-TO engine 150 in accordance with the present disclosure is capable of identifying existing items similar to any new item. The SIM-TO engine 150 may access or receive various data, such as historical data stored in the history databases 120 and data relating to new items received from users. The SIM-TO engine 150 may also generate or cause to generate data. In some embodiments, the SIM-TO engine 150 may monitor new items and item attributes automatically. For example, the SIM-TO engine 150 may monitor a number of pre-selected categories or subcategories and determine whether new items are introduced within the pre-selected categories or subcategories at a predetermined frequency. It should be understood that the SIM-TO engine 150 may gather data from any of computing resources including servers, databases, storage, and the like.

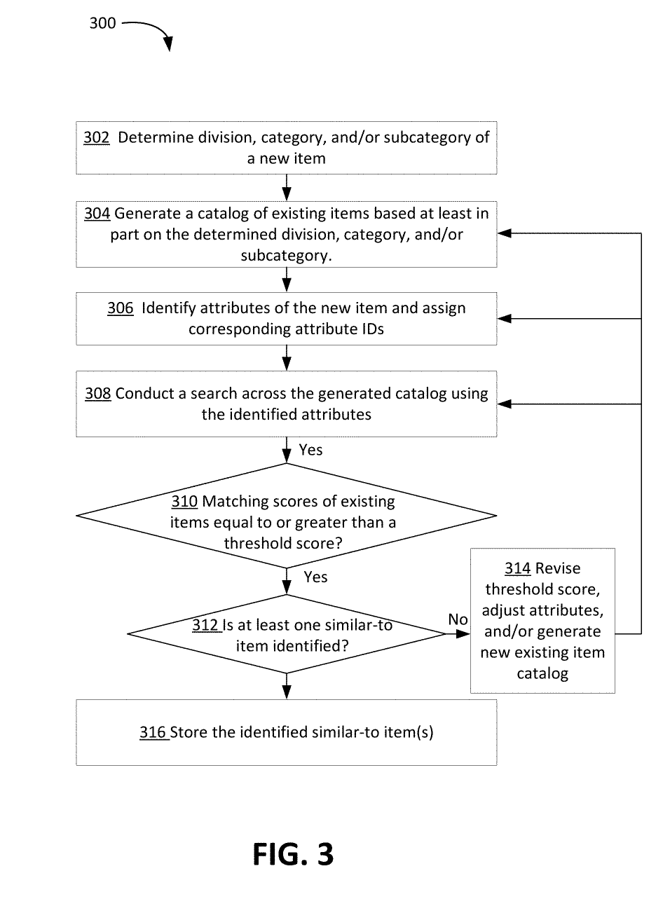

FIG.3 is a flowchart illustrating an example process 300 for identifying similar-to items. A server or other computing devices may be used singly or in combination to implement the similar-to identification process 300. Although depicted as a sequence of operations, those of ordinary skill in the art will appreciate that various embodiments may add, remove, reorder, or modify the depicted operations.

At operation 302, upon receiving data relating to a new item, division, category, and/or subcategory of the new item are determined. The received data may include description of the new item, vendor name, cost price, manufacturer suggested retail price (MSRP). A division, category, and subcategory to which the new item belongs may be determined based on the description of the new item. The division No., category No., and subcategory No. may be identified using an ID lookup table. For instance, if the new item is Kmart men's underwear, its division and corresponding division No. may be Menswear (46); its category and corresponding category No. may be Men's Kmart Underwear (41); its subcategory and corresponding subcategory No. may be Fol Core 4pk Boxer Brief (63). The ID lookup table may be stored locally, in the history database 120, or any other database to which the SIM-TO engine 150 may access.

At operation 304, an existing item catalog is generated based on the division No., category No. and subcategory No. of the new item. Upon determining the division No., category No. and subcategory No. of the new item, the SIM-TO engine 150 catalogs existing items using data stored in the history databases 120 and generate a list of existing items that share the same the division No., category No. and subcategory No. as the new item. It should be appreciated that, depending on the number of exiting items within a specific division, the existing item catalog may be generated based on the division No. of the new item only. In other embodiments, the existing item catalog may be generated based on the division No and category No. of the new item.

At operation 306, a set of attributes of the new item are identified and corresponding attribute IDs are assigned. In some embodiments, the set of attributes may be identified based on the description of the new item. For instance, if the new item is an apparel item, the set of attributes may comprise gender, color, style, material, and so on. In other embodiments, the set of attributes may also include vendor name, cost price and MSRP of the new item. It should be appreciated that, depending on various items, different attributes may be identified. Each attribute is assigned a corresponding attribute ID. In some examples, corresponding attribute IDs may be newly generated and they may be stored into an ID lookup table. In other examples, corresponding attribute IDs may be acquired from a stored ID lookup table.

Operation 308 illustrates conducting a search across the catalog of existing items to match the attributes of the new item. In some embodiments, matching is done via fuzzy logic using Levenstein distance. Because string values of attributes of the new item and existing items are not always identical, Levenstein distance is suitable for a measure of the similarity between the attributes of the new item and those of each existing item within the same division, category, and/or subcategory.

At operation 310, whether matching scores of existing items are greater than a threshold score are determined. In some examples, if an existing item has an attribute matching one among the set of attributes of the new item, a value of “1” is assigned to this existing item; otherwise, a value of “0” is assigned. A matching score of each existing item may be determined by dividing a sum of values assigned to each existing item by the number of attributes among the set of attributes. If the matching score of an existing item is equal to or greater than a predetermined threshold score, this existing item is identified as a similar-to item. Once an existing item is identified as a similar-to item, the existing item may be removed from the existing item catalog.

In other embodiments, the set of attributes may not include MSRP or a national selling price of the new item. In this case, the MSRP or national selling price with a tolerance band may be used to further filter identified similar-to items. For example, MSRP of the new item with a tolerance band may be employed to match regular sale price of identified similar-to items. If the regular sale price of an existing item is outside the tolerance band, this existing item may be removed from a set of identified similar-to items. If, on the other hand, the regular sale price of an existing item falls within the tolerance band, the existing item remains in the set of similar-to items.

Operation 312 determines whether at least one similar-to item has been identified within the existing item catalog. If no similar-to item has been identified after conducting the search across the existing item catalog, the process 300 may proceed to operation 314. If, on the other hand, one or more similar-to items have been identified, the process 300 may proceed to operation 316.

In some embodiments, multiple similar-to items may be identified. If so, the multiple similar-to items may be ranked based on their respective matching scores. In some examples, historical sales data of the similar-to item with the highest matching score may be used as proxy data of the new item to train machine learning algorithms and forecast demand of the new items. In other embodiments, historical sales data of the top two or three similar-to items with the highest matching score may be combined to construct proxy data of the new item to train machine learning algorithms. Historical data of other similar-to items may be used as test data to evaluate forecast accuracy of machine learning algorithms. It should be appreciated that various techniques may be used to construct proxy data of the new item by using historical data of similar-to items identified by the SIM-TO engine 150.

Operation 314 illustrates revising the predetermined threshold score, adjusting the set of attributes, and/or generating a new existing item catalog. In some embodiments, the predetermined threshold score may be revised, and operations 308 through 312 may be repeated. For instance, the threshold score may be decreased so that similar-to item(s) may be identified. In other embodiments, the set of attributes may be adjusted and operations 306 through 312 may be repeated. In some examples, some attributes may be removed from the set of attributes. In other examples, some attributes relating to description of the new item may be amended. In some embodiments, the initial set of attributes can be weighted to indicate relevance of the attributes to a desired result. The weighting can be continuously updated to increase the accuracy of biasing. In another embodiment, criteria of generating a catalog of existing items may also be adjusted and operations 304 through 312 may be repeated. For example, a new catalog including more existing items may be generated based on the determined division only.

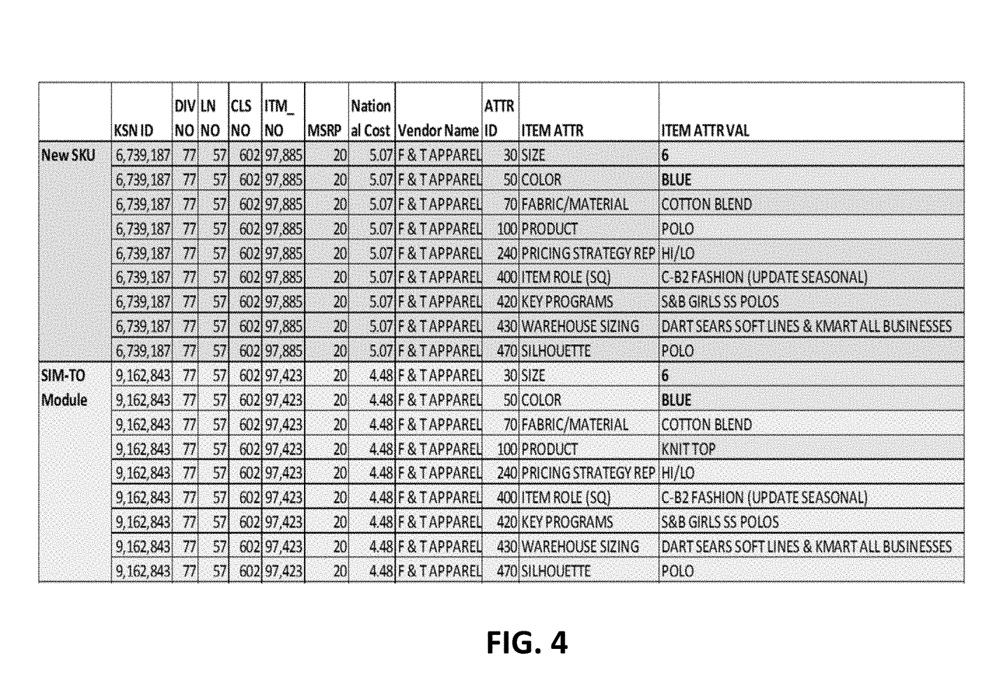

At operation 316, one or more identified similar-to items are stored. The identified similar-to items may be stored locally, in the history databases 120, or other separate storage server or computing device. FIG. 4 illustrates a comparison between the attributes of a new item and those of a similar-to item identified by the SIM-TO engine 150. As shown, the attributes of the identified lsimilar-to item matches those of the new item very well.

Any providers who provide products or services need accurate demand forecast to optimize supply-chain, plan promotions, and minimize operating costs. The forecast engine 130 in accordance with the present disclosure is capable of providing accurate demand forecast. In some embodiments, the forecast engine 130 may forecast demand for a given division, category, or subcategory nationwide or at a region or store level. In other embodiments, the forecast engine 130 may predict demand for a given item at various levels.

In some embodiments, the forecast engine 130 may perform the demand forecast based on machine learning via a machine learning system that includes one or more learning algorithms that learn demand associated with the availability of relevant historical data. In other embodiments, the forecast engine 130 may also perform the demand forecast based on forecasted data and/or a user indication of rules to be used in the demand forecast. For example, the demand forecast for an item within a given division may be extracted from forecasted data for the given division.

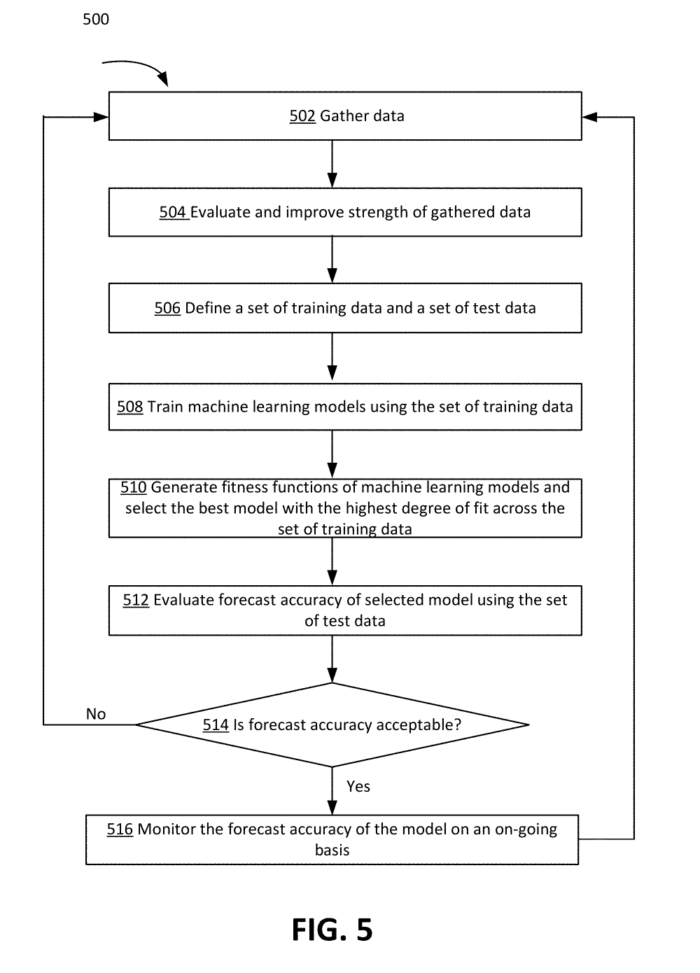

FIG.5 is a flowchart illustrating an example process 500 for demand forecast. A server or other computing device may be used singly or in combination to implement the forecast process 500. Although depicted as a sequence of operations, those of ordinary skill in the art will appreciate that various embodiments may add, remove, reorder, or modify the depicted operations.

At operation 502, data relevant to demand forecast are gathered. The forecast engine 130 may gather data from other components, such as the history databases 120, the SIM-TO engine 150, and the forecast databases 160. The forecast engine 130 may also collect information stored in other locations or resources. The forecast engine 130 may manage various data. The forecast engine 130 may also generate or cause to generate data. The forecast engine 130 may analyze the data, combine or aggregate the data or extract portions of the data as appropriate, and invoke the demand forecast model to generate predicted demand data.

In some embodiments, the forecast engine 130 may be used to forecast demand for a given subcategory at a store level. For that purpose, the forecast engine 130 may collect historical data relating to the items within the given subcategory at the store level. By way of example and without limitation, historical data of the items within the given subcategory may be gathered from the history databases 120. In other embodiments, the forecast engine 130 may be used to forecast demand for a given existing item. To that end, the forecast engine 130 may collect historical data relating to the given existing item from the history databases 120. Preferably, the forecast engine 130 collects historical sales data relating to existing items at weekly intervals over the last three years. It should be appreciated that different data may be gathered to accomplish different forecast goals, such as demand forecast for seasonal items and non-seasonal items. In some examples, an assumption may be made that seasonal items are purchased once per year to cover an annual demand.

In some examples, the forecast engine 130 may be used to predict demand of a new item. In that case, the forecast engine 130 may gather historical data relating to similar-to items of the new item. The similar-to items may be identified by the SIM-TO engine 150. In other examples, a combined sales history of multiple similar-to items may be constructed as proxy data of the new item. In some embodiments, a non-linear function may be developed to model price elasticity and used to de-promote price signals for a data collection with high variance due to price changes. Price effects may be added back during run-time based on published price schedules.

In some cases, the forecast engine 130 may not have access to all available data because doing so would take too much time or require too much storage space to store. In other cases, some of the data may be configured only to be accessible manually or may be unavailable because the data is on a network segment to which the forecast engine 130 does not have access. The forecast engine 130 may use the available information to forecast demand and make an update as more information becomes available.

At operation 504, signal strength of gathered data is evaluated. Various parameters and techniques may be deployed to evaluate signal strength of the data gathered at operation 502. In some embodiments, a temporal length of a data collection and the number of non-zero samples may be used to measure the signal strength. A measurement of the temporal length enables to differentiate items with low frequency variations (e.g., seasonal behaviors) versus items with higher frequency variations. The measurement of the temporal length may also define the number of weeks included in the data collection. The temporal length may be determined by decomposing the data using Fourier Transforms. The number of non-zero samples among the data collection may be counted to determine whether there are enough “excitations” within the data collection for training and test forecast models.

A series of techniques may be used to improve the signal strength of a data collection. If the data collection includes several zero-value weeks (i.e., sales data with slow velocity), “intermittent sales” techniques may be used to address the slow velocity issue. If the data collection lacks sufficient excitations, the data collection may be expanded to cover a larger area. For example, when a data collection gathered at a store level does not include sufficient non-zero historical sales values, the data collection may be expanded by gathering more historical data at a region or nation level. The data collection may also be strengthened by adding data of similar-to items identified by the SIM-TO engine 150.

At operation 506, two separate and independent sets of data are defined. One set of data will be used to train machine learning algorithms. Another set of data will be used to test machine learning algorithms and evaluate their forecast accuracy. In some embodiments, these two sets of data may be different time-series data of the same item(s). In other embodiments, these two sets of data may be historical data of different items. For instance, if multiple similar-to items are identified for a new item, historical data relating to one similar-to item may be defined as test data and historical data relating to other similar-to items may be defined as training data.

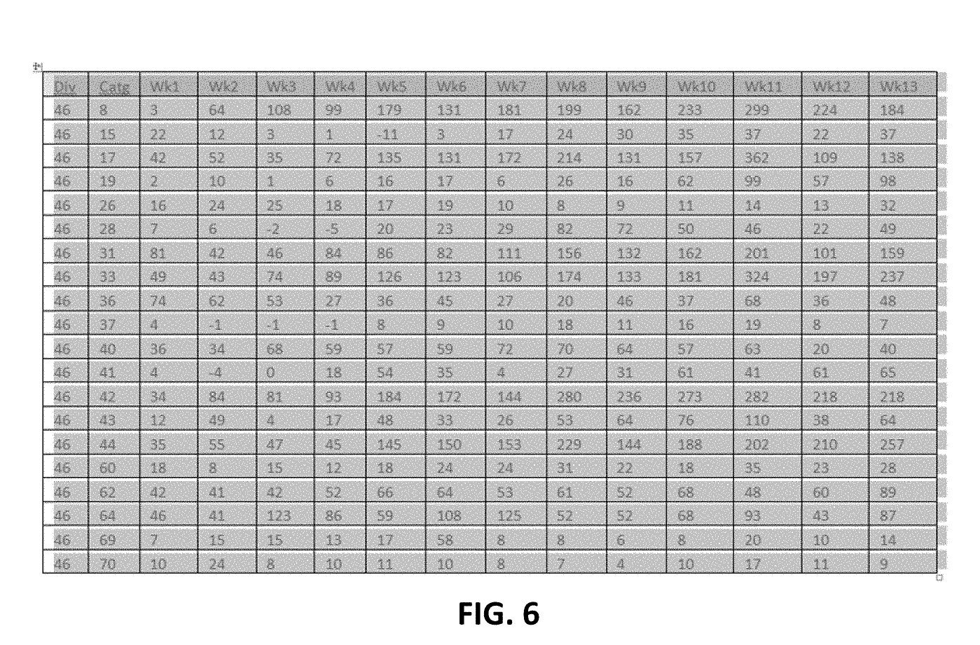

Operation 508 illustrates training machine learning models using the set of training data. Various machine learning models may be employed, such as STL (seasonal trend using LOESS (localized extended state space smoothing))+ETS (exponential smoothing), Holt Winters Exponential Smoothing, and ARIMA (Auto Regressive Integral Moving Average). In some embodiments, the forecast engine 130 may forecast demand for a given division at a store level. A division level forecast may be made using ETS model. This model requires two cycles of historical sales data to make a forecast and is suitable for seasonal forecast. For those items whose historical information was not available at the given division level, the last five weeks of historical data may be used and an ARIMA may be adopted for them. FIG.6 illustrates an example of a forecast for a division of Fall Winter Men's Apparel at a given store in New York. Forecasted sales of each category within the given division for the next thirteen weeks (i.e., Wk1 through Wk13) are shown in the Figure.

In some embodiments, a demand forecast for an item within the given division may be derived from the forecasted data of the given division. In order to extract forecast data for the item, it is necessary to determine what items within the given division were purchased by the given store. For this purpose, the forecast engine 130 may further gather other data, such as inbound purchase orders (POs). A total purchase amount may be determined by summing all of purchase data relating to the given division. A percentage of purchasing a particular item relative to a total purchase amount of items within the given division may then be determined. Assuming that a particular item was purchased in the same volume as it was sold in the past, the purchase percentage may be used to split the division forecast data and predict sales of the particular item.

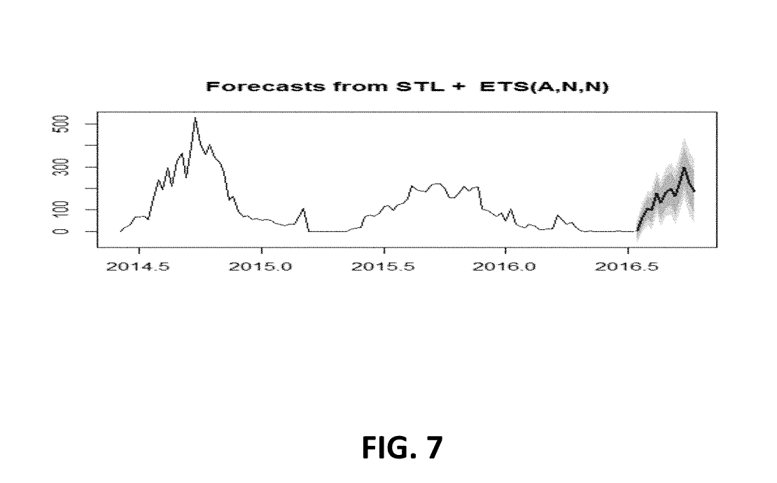

FIG.7 illustrates an example of predicted demand of the item of Men's Fleece within the given division of Fall Winter Men's Apparel for upcoming thirteen weeks. The line surrounded by shaded bands represents the forecast data of this particular item. The darker and lighter shaded bands represent 80% and 95% confidence intervals around the mean, respectively. The shaded bands determine the high and low bounds for the forecasted quantities.

It should be appreciated that the forecast engine 130 may forecast demand for a hierarchy of division, category, subcategory, and item. It should also be appreciated that any lower hierarchy level of forecast data may be derived from a higher hierarchy level of forecast data. In other embodiments, the forecast engine 130 may directly forecast demand for an existing item or a new item using historical data related to the existing item or similar-to items of the new item.

In some examples where historical data contains a large amount of noise, Holt-Winters Exponential Smoothing may be used to develop the forecast model. Unlike some other smoothing methods, such as simple moving average, this technique does not require any minimum number of observations to be made before it begins to produce results. Holt-Winters Exponential Smoothing algorithm uses the level, trend, and seasonal components to generate forecast, and it treats non-seasonal and seasonal trends separately to predict future events.

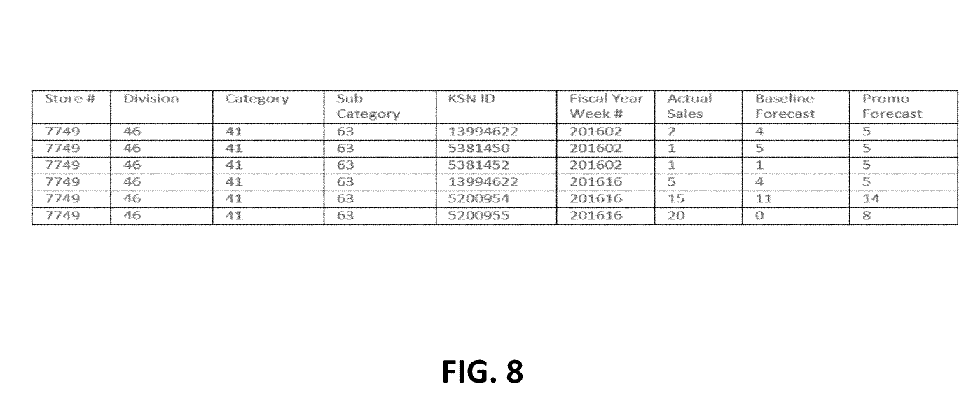

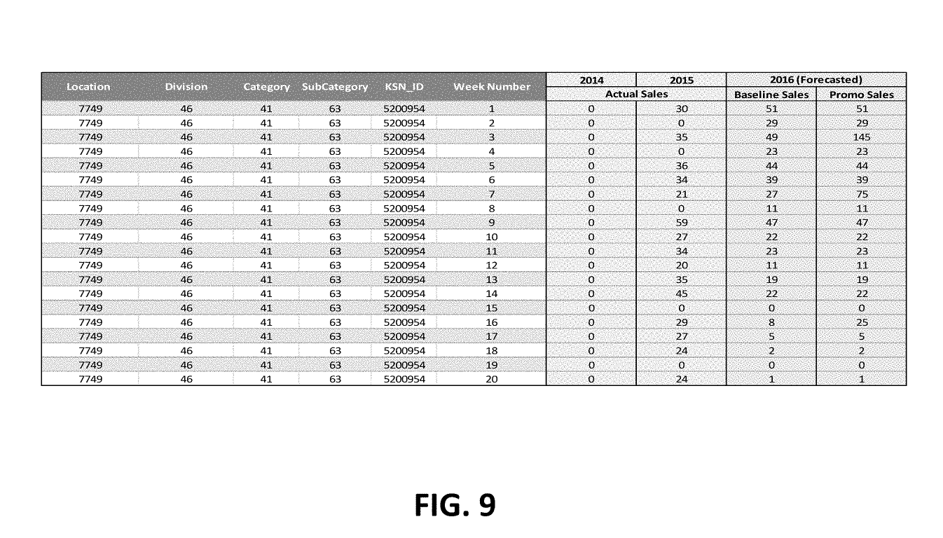

A seasonal Holt-Winters model takes the form: yₜ=b₁+b₂t+Sₜ+ϵₜ, where b₁ is the base signal also called the permanent component, b₂ is a linear trend component, Sₜ is an additive seasonal factor, and ϵₜ is the random error component. If a length of a season is “L” time period, then the seasonal factors are defined so that they add to the length of the season, i.e. Σ_{1≤t≤L}Sₜ=0. Holt-Winters Exponential Smoothing is suitable for promotional forecasting. A lift/increment is an important component in promotional forecasting model, which takes the following factors into consideration: historical regular price, historical promotional price, historical number of units sold, future regular price, and future promotional price. The lift/increment is a function of historical price ratio, future price ratio, and historical sales quantity. Optimal function among linear, polynomial, exponential, power, logarithmic may be fitted to the data and lift/increment may be computed. FIG.8 illustrates a portion of a promotional forecast for a given subcategory 63 (Fol Core 4pk Boxer Brief). FIG.9 shows a promotional forecast for a given item with KSN ID 5200954 (Hans P6 T-shirt White M).

In other embodiments, ARIMA may be used for non-seasonal demand forecast. ARIMA is a parametric model better suited for consumables behavior. Preferably, two cycles of historical data are available for ARIMA to compute forecast. Alternatively, ARIMA may also be adapted for an item whose historical information is not available at a given lower hierarchy level. In this case, ARIMA may use last five weeks of historical data that is either existing historical data of the item or developed from similar-to items. A short period of historical data is a candidate for using ARIMA to compute forecast. For those hierarchy levels where the shape of historical sales is derived from a corresponding higher hierarchy level forecast, numbers computed from ARIMA are multiplied by a scaling factor from a normalized category level forecast.

At operation 510, fitness functions of machine learning models are generated and the best model is selected. As to STL Forecasting (STLF), model fit may be qualified via the p-value that measures the degree of auto-correlation of the residuals. A lower p-value represents a better fit. As to ARIMA, the best model may be identified via the maximum likelihood function on the residuals. In addition, two sets of forecasted values may be computed which are determined by at 80% (1.3 sigma) and 95% (2 sigma) confidence intervals. The best model that has the highest degree of fit across the set of training data is selected.

Operation 512 evaluates forecast accuracy of the selected model using the set of test data. Various techniques may be employed to determine the forecast accuracy. In some embodiments, the forecast accuracy may be measured by comparing forecasted values to actual values using MAPE (mean average percent error), absolute error, and standard deviation. The forecasted values are generated by the model. The actual values are from the set of test data.

Operation 514 determines whether the forecast accuracy of the selected model is acceptable. If MAPE is less than a predetermined threshold, the model is accepted as an operational model of the forecast engine 130 and the forecast process 500 may proceed to operation 516. On the other hand, if MAPE is equal to or greater than the predetermined threshold, the forecast process 500 may return to operation 502 and operations 502 through 514 may be iterated. The predetermined threshold may be defined as 30%, 40%, or any suitable value. It should be appreciated that any other suitable techniques for determining whether forecast accuracy is acceptable may be employed.

At operation 516, the forecast accuracy of an accepted model is monitored on an on-going basis. The forecast data generated by the accepted model may be returned to the user who requested forecast information. The forecast data from the accepted model may be updated over time as the latest data becomes available. For example, the latest sales data collected by the data collectors 110 may be fed to the model, and new forecast data may be calculated. In some embodiments, a time frame for the demand forecast may be specified. For example, a user may want to have an update of the demand forecast over a period of one week or one month. MAPE and standard deviation may be determined upon an update of the forecast data. The forecast accuracy of the accepted model may be monitored on an on-going basis and used as a trigger to iterate operations 502 through 514.

If the forecast accuracy is not acceptable, the forecast process 500 returns to operation 502. During an iterated process, various techniques may be used to adjust data collected by the forecast engine 130 in order to improve forecast accuracy. In some embodiments, “intermittent sales” techniques may be employed to adjust a data collection with several weeks of zero-values. In another embodiment, data may be aggregated across stores grouped regionally and even nationally until sufficient excitations in a data collection are detected. In other embodiments, the SIM-TO engine 150 may be applied to aggregate data across items with the most similarity. When the SIM-TO engine 150 is employed to aggregate data, a set of attributes used to identify similar-to items and/or a threshold matching score may be adjusted to identify additional similar-to items.

In some examples, the forecast engine 130 may construct a data collection for a new item based on historical data of similar-to items identified by the SIM-TO engine 150. For example, three existing items are identified as similar-to items of a newly launched item. The forecast engine 130 may collect historical sales data of the three similar-to items. A proxy for the new item may be constructed by combining historical sales data of the three similar-to items at weekly intervals over the last two years. The forecast engine 130 may forecast the demand of the new item using the proxy data to train and test machine learning algorithms, such as STLF, Holt Winters Exponential Smoothing, and ARMIRA.

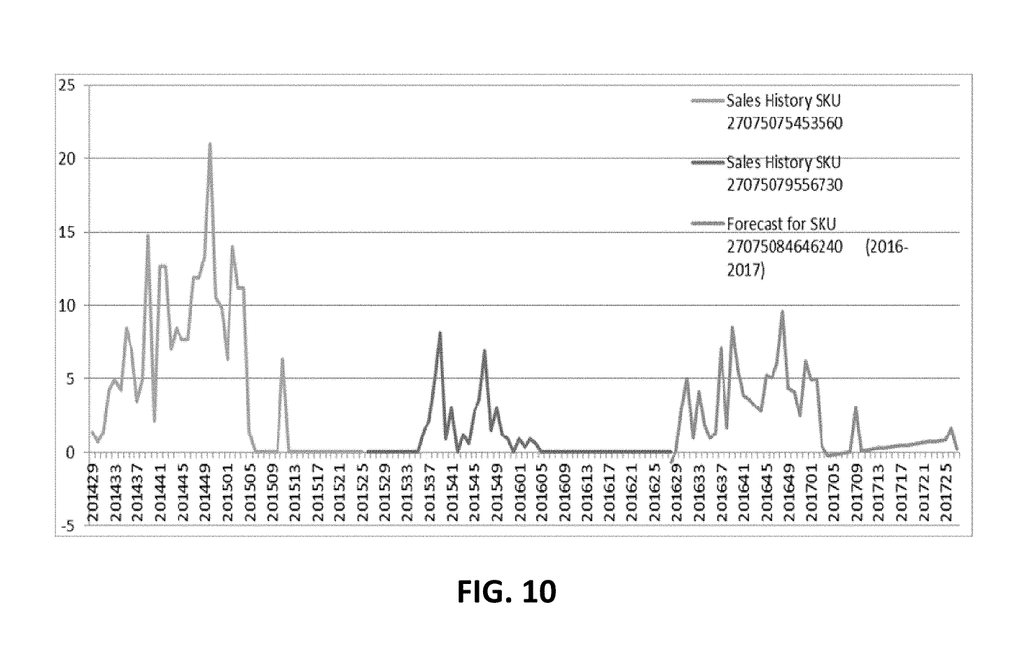

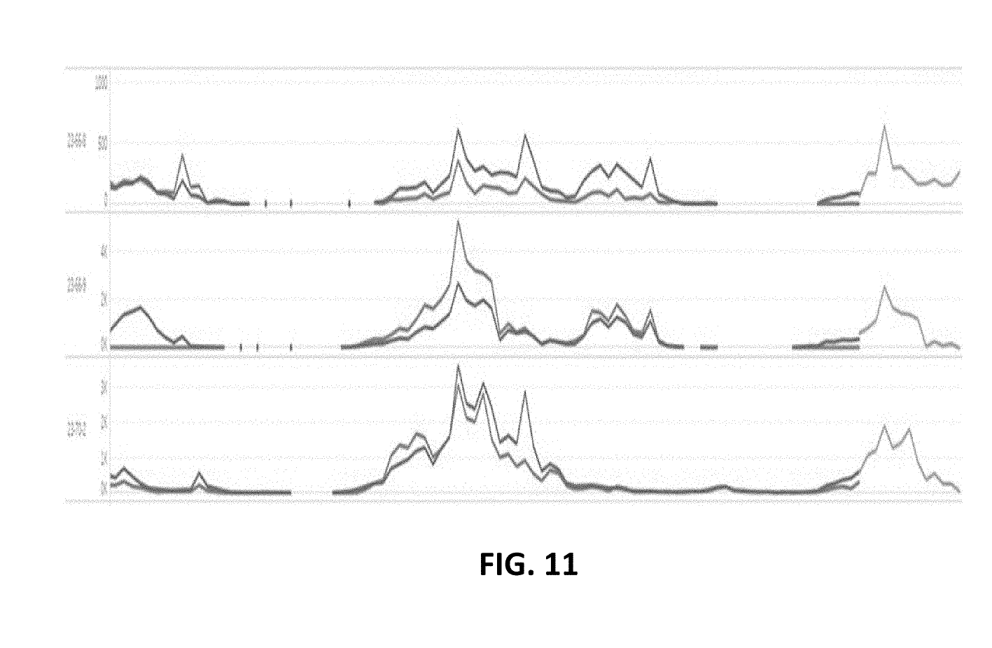

FIG. 10 illustrates an example of a forecast for a newly launched item using combined historical data of three similar-to items. The forecast engine 130 may test the machine learning model using a separate set of data that are not used to train the machine learning model. FIG.11 shows comparisons between actual sales data and predicted data associated with the similar-to items. As shown, the predicted demand profiles look very similar to the actual sales histories.

The above described aspects of the disclosure have been described with regard to certain examples and embodiments, which are intended to illustrate but not to limit the disclosure. It should be appreciated that the subject matter presented herein may be implemented as a computer process, a computer-controlled apparatus or a computing system or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures, and other types of structures that perform particular tasks or implement particular abstract data types.

Those skilled in the art will also appreciate that the subject matter described herein may be practiced on or in conjunction with other computer system configurations beyond those described herein, including multiprocessor systems, microprocessor-based or programmable consumer electronics, minicomputers, mainframe computers, handheld computers, personal digital assistants, e-readers, cellular telephone devices, special-purposed hardware devices, network appliances, and the like. The embodiments described herein may also be practiced in distributed computing environments, where tasks are performed by remote processing devices that are linked through a communications network. In a distributed computing environment, program modules may be located in both local and remote memory storage devices.

A network set up by an entity, such as a company or a public sector organization, to provide one or more services (such as various types of cloud-based computing or storage) accessible via the Internet and/or other networks to a distributed set of clients may be termed a provider network. Such a provider network may include numerous data centers hosting various resource pools, such as collections of physical and/or virtualized computer servers, storage devices, networking equipment, and the like, needed to implement and distribute the infrastructure and services offered by the provider network. The resources may in some embodiments be offered to clients in units called instances, such as virtual or physical computing instances or storage instances. A virtual computing instance may, for example, comprise one or more servers with a specified computational capacity (which may be specified by indicating the type and number of CPUs, the main memory size, and so on) and a specified software stack (e.g., a particular version of an operating system, which may in turn run on top of a hypervisor).

A number of different types of computing devices may be used singly or in combination to implement the resources of the provider network in different embodiments, including general-purpose or special-purpose computer servers, storage devices, network devices, and the like. In some embodiments a client or user may be provided direct access to a resource instance, e.g., by giving a user an administrator login and password. In other embodiments, the provider network operator may allow clients to specify execution requirements for specified client applications and schedule execution of the applications on behalf of the client on execution platforms (such as application server instances, Java™ virtual machines (JVMs), general-purpose or special-purpose operating systems, platforms that support various interpreted or compiled programming languages—such as Ruby, Perl, Python, C, C++, and the like—or high-performance computing platforms) suitable for the applications. This may be done without, for example, requiring the client to access an instance or an execution platform directly. A given execution platform may utilize one or more resource instances in some implementations; in other implementations, multiple execution platforms may be mapped to a single resource instance.

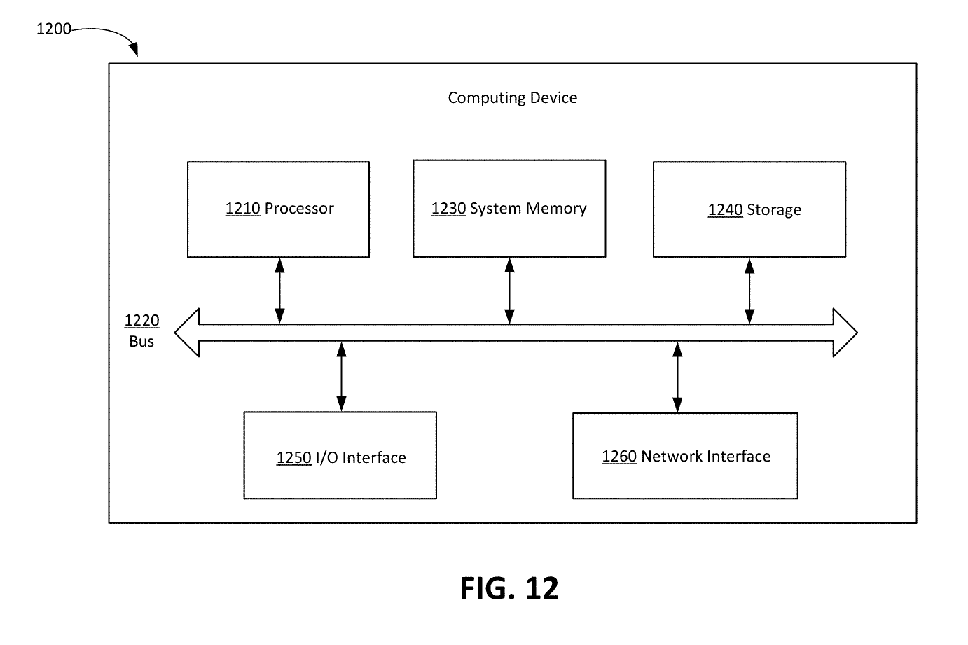

In at least some embodiments, a server or computing device that implements a portion or all of one or more of the technologies described herein, including the techniques to implement the functionality of a forecast engine 130 and a SIM-TO engine 150, may include a general-purpose computer system that includes or is configured to access one or more computer-accessible media. FIG. 12 illustrates such a general-purpose computing device 1200. In the illustrated embodiment, computing device 1200 includes one or more processors 1210 (which may be referred herein singularly as “a processor 1210” or in the plural as “the processors 1210”) are coupled through a bus 1220 to a system memory 1230. Computing device 1200 further includes a permanent storage 1240, an input/output (I/O) interface 1250, and a network interface 1260.

In various embodiments, computing device 1200 may be a uniprocessor system including one processor 1210 or a multiprocessor system including several processors 1210 (e.g., two, four, eight, or another suitable number). Processors 1210 may be any suitable processors capable of executing instructions. For example, in various embodiments, processors 1210 may be general-purpose or embedded processors implementing any of a variety of instruction set architectures (ISAs), such as the x86, PowerPC, SPARC, or MIPS ISAs, or any other suitable ISA. In multiprocessor systems, each of processors 1210 may commonly, but not necessarily, implement the same ISA.

System memory 1230 may be configured to store instructions and data accessible by processor(s) 1210. In various embodiments, system memory 1230 may be implemented using any suitable memory technology, such as static random access memory (SRAM), synchronous dynamic RAM (SDRAM), nonvolatile/Flash-type memory, or any other type of memory.

In one embodiment, I/O interface 1250 may be configured to coordinate I/O traffic between processor 1210, system memory 1230, and any peripheral devices in the device, including network interface 1260 or other peripheral interfaces. In some embodiments, I/O interface 1250 may perform any necessary protocol, timing, or other data transformations to convert data signals from one component (e.g., system memory 1230) into a format suitable for use by another component (e.g., processor 1210). In some embodiments, I/O interface 1250 may include support for devices attached through various types of peripheral buses, such as a variant of the Peripheral Component Interconnect (PCI) bus standard or the Universal Serial Bus (USB) standard, for example. In some embodiments, the function of I/O interface 1250 may be split into two or more separate components, such as a north bridge and a south bridge, for example. Also, in some embodiments some or all of the functionality of I/O interface 1250, such as an interface to system memory 1230, may be incorporated directly into processor 1210.

Network interface 1260 may be configured to allow data to be exchanged between computing device 1200 and other device or devices attached to a network or network(s), such as other computer systems or devices as illustrated in FIG. 1, for example. In various embodiments, network interface 1260 may support communication via any suitable wired or wireless general data networks, such as types of Ethernet networks, for example. Additionally, network interface 1260 may support communication via telecommunications/telephony networks such as analog voice networks or digital fiber communications networks, via storage area networks such as Fibre Channel SANs or via any other suitable type of network and/or protocol.

In some embodiments, system memory 1230 may be one embodiment of a computer-accessible medium configured to store program instructions and data as described above for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media, such as magnetic or optical media, e.g., disk or DVD/CD coupled to computing device 1200 via I/O interface 1250. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 1200 as system memory 1230 or another type of memory.

Further, a computer-accessible medium may include transmission media or signals such as electrical, electromagnetic or digital signals, conveyed via a communication medium such as a network and/or a wireless link, such as may be implemented via network interface 1260. Portions or all of multiple computing devices may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Each of the processes, methods, and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from, or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A demand forecasting system (100), comprising:
a forecast engine (130) configured to generate forecast data;
a history database (120) operatively coupled to the forecast engine;
a plurality of data collectors (110) operatively coupled to the history database;
a SIM-TO engine (150) operatively coupled to the forecast engine;
a forecast database (160) operatively coupled to the forecast engine; and
an application unit (170) operatively coupled to the forecast engine;
wherein the forecast engine and the forecast database are configured to provide inputs to the application unit to plan promotion activities, achieve optimal inventory and resource allocation, and minimize operating costs;
wherein at least some of the forecast data generated by the forecast engine is stored in the forecast database; and
wherein the SIM-TO engine comprises a processor and a computer readable medium containing instructions that, upon execution by the processor, cause the SIM-TO engine to perform a process to identify items that are similar to a new item identified by the data collector, enabling the forecast engine to provide forecast data indicative of a demand forecast for the new item, said process comprising:
determining a classification of the new item (302);
identifying a set of attributes of the new item (306);
calculating matching scores for existing items within the determined classification, wherein the matching scores are calculated using the set of attributes (310); and
identifying an existing item as similar to the new item in response to determining that a matching score for the existing item is equal to or greater than a predetermined threshold value (312).

2. The system of claim 1, wherein the determined classification comprises a hierarchy of classifications, including as a division, a category, and a subcategory, and wherein the process to identify items that are similar further comprises performing an expanded search of existing items by conducting a search within a higher level of classification.

3. The system of claim 1, wherein the process to identify items that are similar further comprises adjusting the set of attributes and the predetermined threshold value so as to identify a desirable number of similar-to items.

4. The system of claim 1, wherein the forecast engine is configured to:
divide gathered data from the data collectors into a set of training data and a set of test data;
train a plurality of machine learning models using the set of training data;
generate fitness functions for the plurality of machine learning models;
select a model with the highest degree of fitness across the set of training data;
evaluate forecast accuracy of the selected model using the set of test data; and
determine whether the forecast accuracy of the selected model is acceptable.

5. The system of claim 4, wherein the system is further configured to update the forecast data generated by the selected model as data associated with existing or similar-to items become available.

6. The system of claim 4, wherein the system is further configured to adjust the data gathered by the forecast engine to improve the forecast accuracy of one or more machine learning models.

7. The system of claim 1, wherein the plurality of data collectors are located in a number of stores of a retail entity and are configured to collect various data relating to items sold by the retail entity, including locations of stores, categories and descriptions of items, times, prices and sales; and wherein the data collected by the data collectors is stored in the history database.

8. The system of claim 1, wherein the forecast engine and the SIM-TO engine are accessible via an application programming interface (API) or user interface, and wherein the forecast engine and SIM-TO engine are configured to provide an analysis and summary of results to a requesting user.

9. The system of claim 1, wherein calculating matching scores for existing items comprises assigning a value of “1” to an existing item if the existing item has an attribute matching one among the set of attributes of the new item, and otherwise assigning a value of “0” to the existing item; and wherein a matching score of each existing item is determined by dividing a sum of values assigned to each existing item by the number of attributes among the set of attributes.

10. In a system comprising a forecast engine configured to generate forecast data, a history database, a plurality of data collectors, a SIM-TO engine, and a forecast database, a method performed by the SIM-TO engine to identify items that are similar to a new item identified by a data collector, said method comprising the steps of:
determining a classification of the new item (302);
identifying a set of attributes of the new item (306);
calculating matching scores for existing items within the determined classification, wherein the matching scores are calculated using the set of attributes (310); and
identifying an existing item as similar to the new item in response to determining that a matching score for the existing item is equal to or greater than a predetermined threshold value (312).

11. The method of claim 10, wherein the determined classification comprises a hierarchy of classifications, including as a division, a category, and a subcategory, and wherein the method to identify items that are similar further comprises performing an expanded search of existing items by conducting a search within a higher level of classification.

12. The method of claim 10, wherein the method to identify items that are similar further comprises adjusting the set of attributes and the predetermined threshold value so as to identify a desirable number of similar-to items.

13. The method of claim 10, wherein the forecast engine performs the following steps:
dividing gathered data from the data collectors into a set of training data and a set of test data;
training a plurality of machine learning models using the set of training data;
generating fitness functions for the plurality of machine learning models;
selecting a model with the highest degree of fitness across the set of training data;
evaluating forecast accuracy of the selected model using the set of test data; and
determining whether the forecast accuracy of the selected model is acceptable.

14. The method of claim 13, further comprising updating the forecast data generated by the selected model as data associated with existing or similar-to items become available.

15. The method of claim 13, further comprising adjusting the data gathered by the forecast engine to improve the forecast accuracy of one or more machine learning models.

16. The method of claim 10, wherein the plurality of data collectors are located in a number of stores of a retail entity and collect various data relating to items sold by the retail entity, including locations of stores, categories and descriptions of items, times, prices and sales; and store the data collected in the history database.

17. The method of claim 10, wherein the forecast engine and the SIM-TO engine are accessible via an application programming interface (API) or user interface, and wherein forecast engine and SIM-TO engine provide an analysis and summary of results to a requesting user.

18. The method of claim 10, wherein calculating matching scores for existing items comprises assigning a value of “1” to an existing item if the existing item has an attribute matching one among the set of attributes of the new item, and otherwise assigning a value of “0” to the existing item; and wherein a matching score of each existing item is determined by dividing a sum of values assigned to each existing item by the number of attributes among the set of attributes.

19. A computer readable medium containing instructions that, upon execution by a processor, cause the processor to perform a process to identify items that are similar to a new item identified by a data collector, said instructions comprising:
instructions for determining a classification of the new item;
instructions for identifying a set of attributes of the new item;
instructions for calculating matching scores for existing items within the determined classification, wherein the matching scores are calculated using the set of attributes; and
instructions for identifying an existing item as similar to the new item in response to determining that a matching score for the existing item is equal to or greater than a predetermined threshold value.

20. The computer readable medium of claim 19, wherein the instructions for calculating matching scores for existing items include instructions for assigning a value of “1” to an existing item if the existing item has an attribute matching one among the set of attributes of the new item, and otherwise assigning a value of “0” to the existing item; and instructions for dividing a sum of values assigned to each existing item by the number of attributes among the set of attributes.
